(19) United States
(12) Patent Application Publication
(10) Pub. No.: US 2004/0039517 A1
(43) Pub. Date: Feb. 26, 2004

(54) Integrated traffic monitoring system

(76) Inventors: Alfred Biesinger, Tuebingen (DE); Ottmar Gehring, Stuttgart (DE); Hannes Omasreiter, Boebligen (DE); Michael Schliep, Aichtal (DE); Szaboles Toergyekes, Stuttgart (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/363,554

(22) PCT Filed: Aug. 24, 2001
(86) PCT No.: PCT/EP01/09783

(51) Int. Cl. G08G 1/00

(52) U.S. Cl. 701/117; 340/907

(57) ABSTRACT

The invention relates to an integrated traffic surveillance system having devices for measuring environmental and weather data, having traffic sensors, and a traffic surveillance control centre for storing and processing the detected data, and communication devices for carrying out the data exchange with the measuring devices and with the data users. The invention also relates to a driver assistance system which operates autonomously or is part of the integrated traffic surveillance system. It is proposed according to the invention that in order to reduce the environmental pollution the integrated traffic surveillance system and/or the driver assistance system take actions to control a traffic system. The control actions comprise the output of information, warnings and/or recommendations to road-users, interventions in the infrastructure and/or interventions in the vehicle.

The invention also relates to a digital map which is part of the integrated traffic surveillance system and/or the driver assistance system. It is proposed according to the invention that immission data are stored as attributes in the digital map.

The invention relates to an integrated traffic surveillance system in accordance with the preamble of claim 1, a driver assistance system in accordance with the preamble of claim 28 which operates autonomously or is part of the integrated traffic surveillance system, and a digital map in accordance with the preamble of claim 42 which is part of the integrated traffic surveillance system and/or part of the driver assistance system.

A traffic surveillance system of generic type is described in EP 0 527 307 A2. It is known from this document to collect traffic data, weather data and environmental data for a zone in a traffic surveillance control centre and to compose an areal image of the environmental pollution situation in this zone. These data are subsequently forwarded to external users via communication devices.

A driver assistance system having a digital map and means for determining position is described in DE 198 59 645 A1. The digital map in the vehicle is supplemented by a digital map in an external central server which communicates with the internal vehicle systems via mobile communication. Traffic information, current data relating to traffic density distributions, traffic jams, accidents, construction sites, road blocks, diversions, changed rules of right of way, meteorological conditions of heavy precipitation, glazed frost formation, storm gusts etc. are stored as attributes in the digital map. The digital map is used for destination guidance taking account of current conditions as they are described by the attributes.

A digital map, stored in a control centre, of a traffic road network with assigned static and dynamic attributes is described in DE 196 50 844 A1. Static attributes comprise at least structural features of the traffic routes such as number of lanes, upgrades/downgrades and type of road. Starting values of dynamic attributes are derived once from the structural features and adapted continuously to the real conditions of the respective traffic routes.

DE 198 35 558 A1 discloses a driver assistance system having a digital map and means for determining position which carries out a route calculation with the inclusion of means of public transport. The driver assistance system is fed timetable data of means of public transport, which are also included in the route planning. Criteria for preferring means of public transport to the vehicle are, for example, saving the user from looking for a parking space in the city centre and, possibly, shortening his journey time.

DE 299 17 676 U1 describes a traffic management system for means of public transport in the case of which account is taken, for the route planning, of risk factors such as, for example, environmental influences on routes travelled by means of public transport. The user can then choose, for example, between a more polluted, quick route and a longer one which is, however, less polluted by environmental influences, in return.

The collection of traffic situation data by means of sensors on the vehicle, and the transmission of the data into a control centre where these are processed is disclosed, for example, in EP 0 879 459 B1. Also known are options for intervening electronically in the drive train of a vehicle from environmental points of view. U.S. Pat. No. 5,983,156 describes a control of the fuel feed in the case of which the control characteristic is matched to a determined position of the vehicle. Use is made in some regions, for example, of the characteristic optimized for consumption, in others of a characteristic which is optimized with reference to pollutant emissions. The characteristics can also be transmitted from a control centre into the vehicle as a function of position. For this purpose, geographical regions are assigned characteristics for controlling the fuel feed in a digital map. DE 196 37 209 A1 describes a control of the drive train of a motor vehicle which takes account of the current local environmental conditions such that the driving style matched to the environmental conditions is displayed to the driver and, if appropriate, also carried out automatically. The environmental data can be received from a control centre and/or be measured locally in the motor vehicle. The local environmental limit values are taken into account in this case.

Although modern vehicles are becoming ever more environmentally friendly, for example owing to interventions, known from the prior art, in the technology of engines, drive trains and catalytic converters, there is a considerable requirement, in particular in conurbations, for action to improve the environmental compatibility of road traffic. The reason for this is that, firstly, the increase in traffic in recent years has as a whole compensated in part the substantial reduction in pollutant emission from individual vehicles, and secondly the tolerance of the population towards immissions caused by traffic has been dropping continuously. The latter circumstance is also reflected, inter alia, in a permanently more stringent environmental legislation which in part prescribes that the introduction of severe traffic-limiting measures is to be examined by the municipalities as early as the overshooting of specific annual test values for air pollutants. Because of the formation of annual averages, such measures are generally inflexible and also impair the efficiency of the traffic system at times when there is no need for action because of low pollutant concentrations, for example given good conditions of air exchange. In this case, a limit value fixes a value for which a previously set measure must be taken upon its being overshot. A test value is a value for which it is necessary upon its being overshot to check which of the measures available for selection is most suitable to be taken.

The term immission is understood as the pollution at the location of effect; this pollution is generally associated with the air and can be caused by environmental pollution such as, for example, pollutants, noise, smell, etc. The term environmental data describes the environment per se, that is to say, for example, wooded area, river meadow, sealed ground. The term environmental pollution covers immission pollution (associated with the air) and other pollution of the environment, for example in water and ground.

The term traffic system covers all persons and equipment participating in the traffic, that is to say pedestrians, vehicles with occupants, the infrastructure (for example signalling systems, traffic signs, including those with changing displays, beacons, the road traffic network with safety devices, respective control centres), others intervening in the traffic such as police units including police station, special-use vehicles including deployment centre.

It is an object of the present invention to develop the traffic surveillance system described at the beginning, the driver assistance system described at the beginning and the digital map described at the beginning in such a way that environmental pollution caused by traffic, in particular in conurbations are reduced. It should be possible for this reduction to be handled flexibly and in a locally effective fashion and for it to be associated with the lowest possible pollution for the road-users. This object is achieved according to the invention for the integrated traffic surveillance system by means of the characterizing features of claim 1, for the driver assistance system by means of the characterizing features of claim 28, and for the digital map by means of the characterizing features of claim 42. The subclaims relate to advantageous refinements and developments of the invention.

The integrated traffic surveillance system is based on data, traffic data, weather data and environmental data, which are detected by sensors and are collected for a zone in a traffic surveillance control centre. A three-dimensional and/or areal image of the immission situation in this zone is created and evaluated in the traffic surveillance control centre. In addition to the passive collection of data, the traffic surveillance system actively influences the traffic by interventions in the infrastructure, by interventions in the vehicles, for example their control systems, and/or by advice to road-users, and thereby achieves a reduction in the emission and immission pollution (for example pollutants, odorous substances, noise).

In an advantageous development of the traffic surveillance system, the detection of environmental data, weather data and traffic data is performed both with the aid of mobile and stationary measuring stations and by sensors on the vehicle. The stationary measuring stations can be used to record a basic image of the pollution situation of a zone. The mobile measuring stations can be brought into use at locations where measurements need to be done for a limited time. Moreover, the sensors on the vehicle permit a very fine image with many local measuring points whose density is, moreover, greater on routes with heavy traffic. The combination of these mobile and stationary sensors permits very detailed knowledge of the pollution situation of a zone that can be assigned accurately in terms of location.

In a further advantageous development of the traffic surveillance system, the traffic surveillance control centre not only collects the detected data and determines a three-dimensional and/or areal immission situation therefrom, but also makes predictions for the further development of the situation. Techniques such as, for example, neuronal networks or fuzzy logic can be used to make the predictions. The predictions supplement the image of the current immission situation by a knowledge of the likely situation in the future, and this can be taken into account in the case of the measures taken.

In a development of the traffic surveillance system, the traffic surveillance control centre not only collects immission data and predictions for the further development of the situation, but also detects and evaluates weather and/or traffic data and makes predictions for their further development. The predictions supplement the image of the current weather and traffic situations by a knowledge of the likely future situation, and this can be taken into account in the measures taken. Techniques such as, for example, neuronal networks or fuzzy logic can be used to make the predictions. The joint consideration of weather, traffic and immission data can be used to obtain a comprehensive image of the total situation, and stable, informative predictions can be made on the basis thereof.

The traffic surveillance system advantageously comprises a digital map with data relating to the road traffic network and the traffic infrastructure. Data are entered as attributes into the digital map. Immission data and/or emission sources are suitable in particular for the present traffic surveillance system as data for the attributes in addition to conventional ones such as geographic data, topographic data, weather data, data relating to the geometry of the road network, traffic data etc.

The digital map is advantageously located at least in the traffic surveillance control centre, where, in detail, for example, the immission situation detected in three dimensions and/or over an area, the evaluation of this situation, predictions for the further development of the immissions, immission statistics and statistical immission data such as immission sensitivity and immission limit values are entered as attributes into the digital map. The attributes can be assigned accurately in terms of location and time and are the basis on which it is possible to take precise measures in terms of location and time. In addition to immission data, weather and traffic data with statistics and predictions therefore are also entered as attributes into the digital map.

The traffic surveillance system can advantageously be implemented by comprising an on board driver assistance system. The driver assistance system extends the range of action of the traffic surveillance system to the vehicles as well, for example by intervention in the control systems of the vehicle.

In a development of the invention, the traffic surveillance control centre and/or the driver assistance system can undertake interventions in a traffic system. This allotment increases the range of options for the traffic surveillance system to intervene in traffic, and so measures can develop a greater effectiveness. In this case, as part of the traffic surveillance system, the driver assistance system preferably executes control actions in the vehicle. These are coordinated with the traffic control actions of the traffic surveillance control centre. In this case, interventions by the traffic surveillance control centre advantageously refer to interventions in the traffic infrastructure which must be centrally coordinated, for example, the control of luminous signalling systems, traffic surveillance systems, toll registration equipment, systems which have an active effect on the surface condition of the road network, for example, roadway heating or deicing, speed restrictions and/or recommended diversions. A high efficiency is achieved in the traffic surveillance system by means of this cooperation in the overall traffic network and by the use of immission predictions.

In a further design of the invention, the road-users are informed optically and/or acoustically, as required, of the nature of the measures instituted. This information possibly also comprises the reasons for the intervention, and so it is possible to expect more understanding for the measures on the part of road-users.

In an advantageous design of the invention, the immission pollution can be lowered as required, particularly in certain problem zones of the traffic network, or globally with reference to the overall zone covered, by means of the interventions of the traffic surveillance system in the traffic system. Thus, the system becomes flexible and can be adapted to the particular requirements, for example to different times of day or seasons.

In a further advantageous design, the driver assistance system is expanded by a digital map with immission data as attributes. As a result of this design of the invention, necessary data of the digital map are present, on the one hand, in the traffic surveillance control centre and, on the other hand, in the driver assistance system. Moreover, the attribute data of the digital map in the traffic surveillance control centre and of the digital map in the driver assistance system supplement one another.

In a further embodiment of the invention, the driver assistance system in the vehicle independently determines an image of the three-dimensional and/or areal immission, weather and/or traffic situations with the aid of the data which are currently present in the vehicle. These are, for example, data of its sensors and data which have been received from the traffic surveillance control centre and stored in the vehicle if required, and/or data which have been determined in the vehicle. In conjunction with data from the digital map, the driver assistance system independently makes predictions for the development of immission, weather and/or traffic situations and independently evaluates the necessity for instituting measures. The independent approach of this embodiment also has the advantage that decisions can be made and measures taken in individual vehicles without losing time by communicating with and querying a control centre.

The traffic surveillance control centre and the driver assistance system advantageously exchange information. In this case, on the one hand recommendations, instructions, information and/or warnings, in particular covering the traffic, weather and immission situation over wide areas and in regions and/or information for intervention in vehicle control are transmitted to the driver assistance system by the traffic surveillance control centre via communication devices. On the other hand, the driver assistance system also transmits to the traffic surveillance control centre via communication devices recommendations, instructions, information and/or warnings, in particular covering detected sensor data, covering the traffic, weather and/or immission situation determined in the vehicle, and covering status data of the vehicle. This is done, for example, by exchanging attributes of the digital map. As a result of this, the digital map in the traffic surveillance control centre and the digital map in the driver assistance system supplement one another in such a way that the data produced in the respective system and/or frequently required data are present locally and are supplemented if required by transmitting data of the digital map of the respective other site.

Measures which can be taken advantageously with the aid of the driver assistance system or which it takes independently comprise the proposal or the automatic selection of an alternative driving route which is more environmentally friendly, for example for the purpose of using a route currently suffering less pollution. Furthermore, the measures comprise instructions, information, recommendations, warnings and/or interventions which lead to a more environmentally appropriate driving style. The measures also comprise the proposal to the driver and the other vehicle occupants to switch to other means of transport, for example public transport.

Further advantageous measures are interventions in control systems of the vehicle and/or the selection of another drive source, for example an electric drive which is present in addition to the internal combustion engine. Using this set of possible measures, the driver assistance system is capable with or without connection to the traffic surveillance control centre, of taking the measure or the measures which is/are best suited to the current emission or immission situation.

In this case, the driver and the other vehicle occupants are informed, depending on need, of the vehicle interventions, are warned of them, are recommended measures or are instructed thereof. As a result, a communication with the users and a possible feedback via the users is provided in the traffic surveillance system. The measures are advantageously applied in stages, such that the effects on the riding comfort are as slight as possible, but at the same time the emissions of the vehicle are likewise kept as low as possible. A higher acceptance of the measures on the part of the road-users can be expected owing to the least possible impairment of the riding comfort.

The route planning and destination guidance system can be fitted with an alerting function. For this purpose, the user must specify the desired target location and the desired time of arrival at this location, the system plans a route and determines the required time of departure to reach the target punctually, taking account of additional information. The additional information used comprises, for example, traffic information, weather information, environmental data. The system alerts the user at the time of departure, for example, by means of a signal, for example to a specified telephone number. In this case, the user can specify the time interval at which he wishes to be alerted before the actual time of departure.

The measures of the traffic surveillance system relate to all road-users, that is to say also, for example, to pedestrians and cyclists, and by means of appropriate instructions, recommendations, warnings and information makes it possible for them to avoid specific regions which are temporarily particularly polluted. This design of the system has the advantage that these road-users also profit from the traffic surveillance system and are exposed to a lesser immission pollution. These measures can be particularly valuable for the sick, for example, asthmatics, or sports persons.

In a development of the system, the traffic surveillance system intervenes not only to reduce the environmental pollution in the traffic system, but also, in addition, to improve the traffic flow. The advantage consists in that only one system need be operated and maintained. Moreover, it is possible to estimate the negative effects on the traffic situation of the measures for reducing the environmental pollution, and these can be corrected, or at least reduced by means of corrective measures for traffic control.

The driver assistance system in the vehicle autonomously determines the local traffic parameters and/or the local immissions with the aid of its sensors, determines the three-dimensional and/or areal traffic and/or immission situation with the aid of calculating algorithms, makes predictions for the development of the traffic and/or immission situation, and evaluates the necessity to issue measures in order to reduce the environmental pollution. For this purpose, sensor data are, for example, compared with limit values, test values or tolerance ranges stored in tabular form. If the determined immission pollution lies in this case below the prescribed limit values and test values, or in a prescribed tolerance range, no measures are taken. However, if the determined immission pollution overshoots the prescribed limit values or test values or if it leaves the prescribed tolerance ranges, the decision is taken to institute measures.

In a further design of the invention, the driver assistance system evaluates not only the three-dimensional and/or areal traffic and/or immission situation, but also makes predictions of their further development. The decision to institute measures is then taken on the basis of the current and/or the predicted traffic and/or immission situation.

In a design of the invention, sensors which are fitted on the vehicle comprise sensors for detecting environmental data such as, for example, pollutants and noise, weather data, such as, for example temperature, rain, brightness, and traffic data such as, for example, the vehicle's own speed, the speeds of other vehicles in the surroundings of the vehicle, the vehicle's own acceleration, the accelerations of other vehicles in the surroundings of the vehicle, time gaps between vehicles, traffic density, proportion of lorries in the traffic. Data in the vehicle and in the immediate surroundings of the vehicle can be accurately detected by means of the sensors, and thereby form a solid basis for determining the three-dimensional and/or areal traffic and/or immission situation and for predictions as to their further development.

The driver assistance system can advantageously be developed with the aid of a digital map. In addition to other data, for example, weather and traffic data, immission data are entered in this map as attributes. Immission data comprise the determined, evaluated and predicted immissions, as well as limit values, test values, tolerance ranges, statistics and immission sensitivities. The attributes can be assigned accurately in terms of location and time and are the basis for being able to take precise measures in terms of location and time.

In a further preferred design of the invention, the driver assistance system not only judges whether measures are required to reduce the environmental pollution, but institutes them as well. The measures comprise both outputting information, instructions, warnings and/or recommendations to the vehicle driver and the passengers, and the direct intervention of the driver assistance system in the vehicle, particularly in electronic control systems. Thus, the driver assistance system has available a multiplicity of possible measures for reducing the environmental pollution. Particularly advantageous measures are, for example, the proposal and/or the automatic selection of an alternative driving route, recommendations, instructions, information and/or warnings relating to driving style and/or the proposal to switch to means of public transport and/or the intervention in the control unit 7 and/or other systems of the vehicle and/or the automatic selection or the proposal of an alternative drive source for the vehicle.

The proposal and/or the automatic selection of an alternative driving route is performed with the aid of a route planning and destination guidance system. If the destination guidance is not currently active, an attempt is made to recognize the driving route selected by the driver himself from statistical and/or logical points of view. For this purpose, frequently used routes can be stored with time of day, day of the week, vehicle occupancy etc. and can be compared with the current route, time of day, day of the week and vehicle occupancy. On a weekday in the morning, the daily journey to work is then determined, for example, as the route on which the vehicle is currently located. If a recognition does not occur, a prompt for activating the destination guidance is given. The support provided by the destination guidance system saves the driver from having to drive on strange routes without support, something which he would reject in some circumstances, particularly in conurbations.

In further preferred designs of the invention, the driver assistance system outputs to the vehicle occupants instructions, information, recommendations and/or warnings which relate to the selection of a driving style which spares the environment, and/or to switching to means of public transport. The recommendation of or instruction for a different style may make the driver aware for the first time, and thereby enables him to contribute to reducing the environmental pollution by means of a different driving style. The proposal to switch to other means of transport, for example public transport, is made with the aid of the route planning and destination guidance system, which is supplemented by public transport timetables. Moreover, park and ride sites are entered in the digital map and therefore ensure a switch to public transport with the certainty of a parking space and with the certainty that the stop in question is currently being served by means of transport. In addition to this, it is possible to specify the time of arrival at the destination and the duration of a possible additional walk. The supporting of the vehicle driver and the passengers by instructions, information, recommendations and/or warnings and support in planning makes it easier for the vehicle occupants to switch to means of public transport.

A development of the driver assistance system relates to measures for direct intervention in the vehicle. In this case, interventions are undertaken in the control systems of the vehicle, for example the gearbox and/or the fuel injection, and/or an alternative drive source is selected, for example an electric motor also present on board. The intervention is then performed in such a way that, for example, the vehicle emits fewer pollutants and/or causes less noise.

The driver and the other vehicle occupants are informed in this case, if necessary, of the vehicle interventions or are warned of them, they are recommended interventions or they are instructed to that purpose. Consequently, the driver assistance system is provided with communication with the users and possible feedback via the users.

The different measures of the driver assistance system can be applied in different stages, in a fashion adapted to the immission situation. Consequently, the vehicle occupants are impaired as little as possible by a reduction in riding comfort, and this increases acceptance of the system.

The route planning and destination guidance system can be fitted with an alerting function. For this purpose, the user must specify the desired target location and the desired time of arrival at this location, the system plans a route and determines the required time of departure to reach the target punctually, taking account of additional information. The additional information used comprises, for example, traffic information, weather information, environmental data. The system alerts the user at the time of departure, for example, by means of a signal, for example to a specified telephone number. In this case, the user can specify the time interval at which he wishes to be alerted before the actual time of departure.

The driver assistance system can also be part of the integrated traffic surveillance system. The advantage is that it can then be operated autonomously in a zone without a traffic surveillance system. However, in a zone with a traffic surveillance system it can be coordinated and integrated as part of the overall system by the traffic surveillance control centre. Thus, the driver assistance system is used in an optimized fashion oriented towards the general conditions.

The digital map is part of a traffic surveillance system and/or a driver assistance system. It comprises route data of a drivable road traffic network, and additionally assigned attributes. The attributes comprise, for example, environmental, weather and traffic data, and immission data, in particular.

In advantageous embodiments, the attributes are divided into static and dynamic attributes, the static attributes being based at least on structural and geographical features of the traffic routes. The immission-referred static attributes advantageously include indices for the immission sensitivity, that is to say, for example, sensitivity to noise, pollutants, odours and traffic, and the immission limit values, that is to say, for example, for limit values for the traffic routes and their surroundings which relate to noise, pollutants, odours and traffic. These static attributes can be determined, for example, from the geographical position, the topography, the extent of building cover, the type of road, the synoptic, regional and local climatic conditions. Immission-related dynamic attributes include, for example, locally and temporally assignable pollution owing to pollutants, odours and noise, predictions therefore and statistics relating, for example, to pollution owing to pollutants, odours and noise. Together with the attributes described, the digital map is of fundamental importance for measures in the traffic surveillance system and/or the driver assistance system for reducing the environmental pollution. The digital map can be stored either in the control centre and/or in the driver assistance system. It is thereby possible to achieve storage close to the site where the data are processed and/or produced.

Preferred exemplary embodiments of the invention are described below with the aid of the associated drawings, in which, in a diagrammatic illustration in each case:

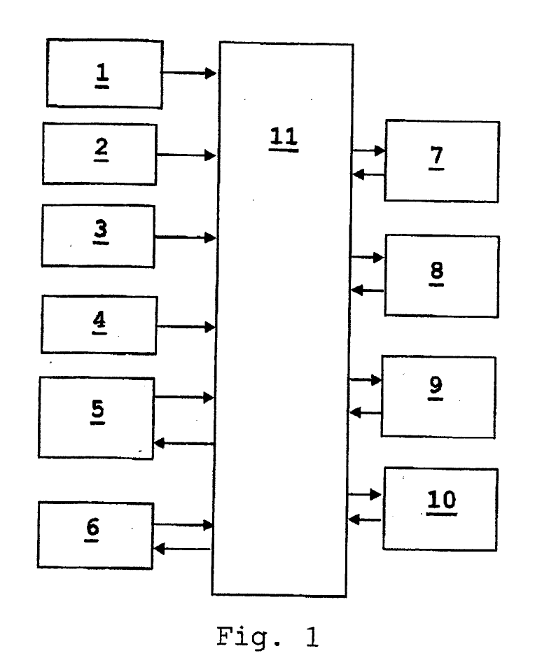

FIG. 1 shows a block diagram of a driver assistance system,

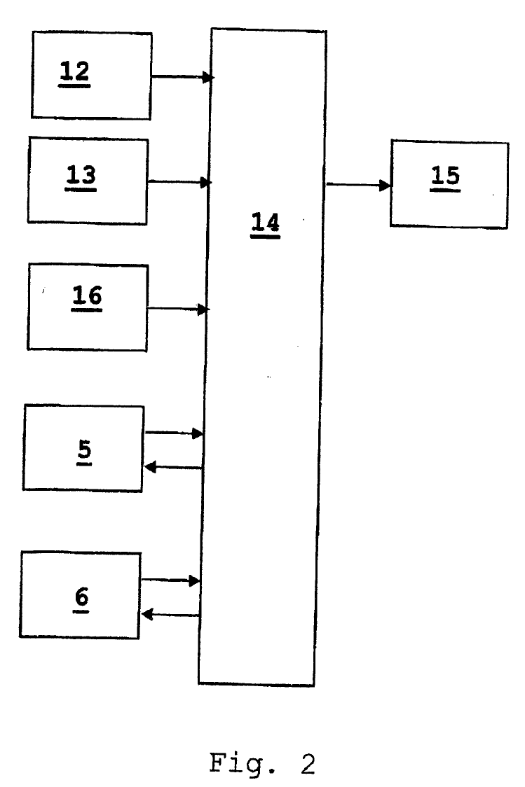

FIG. 2 shows a block diagram of a traffic surveillance control centre with its surroundings,

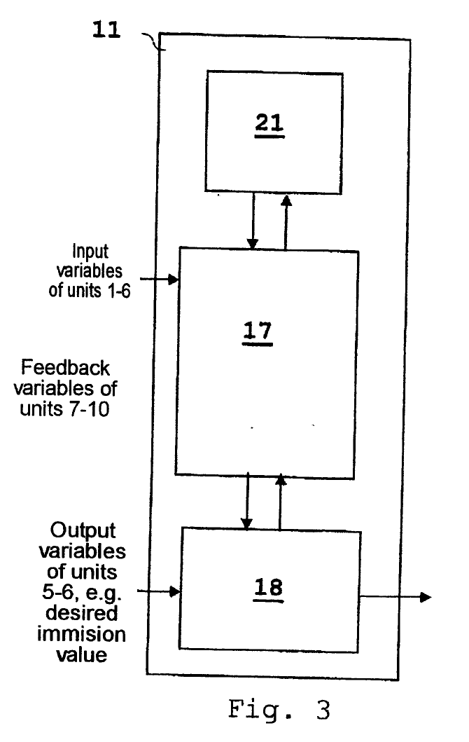

FIG. 3 shows a block diagram of an information processing unit which is part of the driver assistance system, and

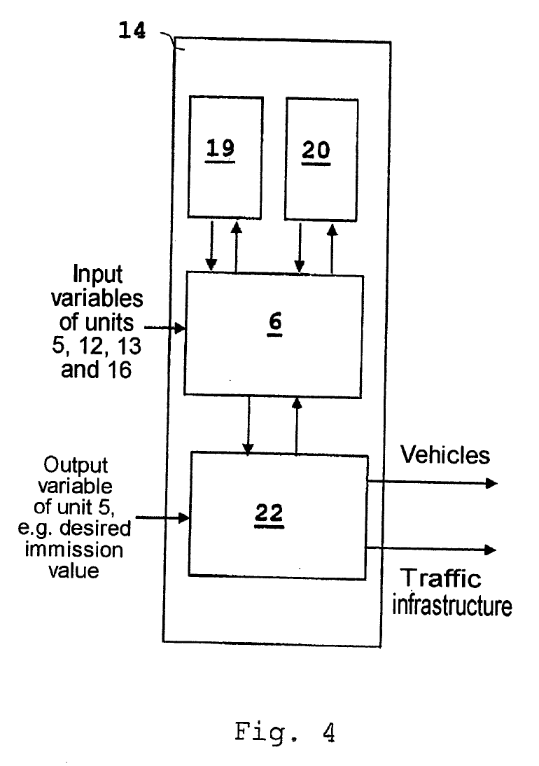

FIG. 4 shows a block diagram of the internal structure of the traffic surveillance control centre.

The structure of the driver assistance system in the vehicle is illustrated in FIG. 1. Entered in a digital map 6 are, for example, attributes relating to geographical, geometrical and topographic properties of the road network, and relating to the traffic and weather situation, and the sensitivity of individual road segments or urban areas to noise, pollutants, odours and traffic.

These attributes are, for example, indices determined on the basis of the geographical position, the topography, the extent of building cover, the traffic conditions, the synoptic, regional and local climatic conditions and the pollutant and noise stresses determined synoptically, regionally and locally.

The locating unit 1, for example Global Positioning System (GPS), is used to fetch from the digital map 6 the indices which are valid, for example, for the zone in which the vehicle is moving. In addition to this location-dependent information, the current time of day, the date, the ambient temperature, the amount of precipitation and brightness, for example, are available from an on board sensing system 2 to an information processing unit 11 of the driver assistance system.

Current measured values for pollutants and noise are detected by an immission sensor 3 located on board, and current traffic parameters are detected by a traffic sensor 4 located on board. With the aid of a communication device 5, current data, for example relating to the synoptic and regional traffic, weather and immission situation, are received from a control centre 14 illustrated in FIG. 2 via the communication device 5 and made available to the information processing unit 11.

The information processing unit 11 uses the input variables generated by the devices 1-6 to determine all the values for pollutants and odours such as, for example, CO, NOx, soot and benzene concentrations as well as weather, traffic and further environmental data. The information processing unit 11 evaluates the urgency of interventions for raising the environmental compatibility, and then activates the functions implemented by the devices 7-10 depending on the situation.

Methods of artificial intelligence such as, for example, neuronal networks or fuzzy logic are used in the information processing unit 11.

The control unit 7 coordinates and controls all the interventions in the control systems of the motor vehicle, for example, in the drive train, there being a plurality of activation stages for the interventions. Each activation stage has different effects on the riding comfort and on the emission of pollutants, odours and noise. The appropriate activation stage is used depending on the situation determined by the units 1-6. In the event of noticeable losses of riding comfort, the driver and the vehicle occupants are informed via the operating and display unit 9.

In the event of an intense immission situation, an extended route planning and destination guidance system 8 is used to check whether an alternative driving route is more environmentally friendly overall: if appropriate, this is proposed to the driver and/or automatically selected. If the destination guidance is not activated, either an attempt is made to recognize the driving route selected by the driver himself (for example daily drive to work) or, if recognition does not occur, advice is given to activate the destination guidance. The operation and output of the destination guidance can also be performed on the operating and display unit 9. The environmental mobility adviser 10 provides recommendations, instructions, information and warnings relating to driving style (for example selection of vehicle speed) or for switching to other means of transport (for example means of public transport) and for routing to the next P&R stop. The environmental mobility adviser is supported in this case by means of the functions of the display and operating unit 9 and the route planning and destination guidance system 8.

Moreover, the driver can be informed directly about the current synoptic, regional and local immission situation, for example pollutant, odour and noise situation and/or the traffic situation via the operating and display unit 9.

FIG. 2 shows the block diagram of the traffic surveillance control centre 14 of the traffic surveillance system for influencing the pollution from pollutants, odour and noise situation and/or the traffic situation. The traffic surveillance control centre 14 can be combined in the traffic surveillance system with the driver assistance system in the vehicle. The traffic surveillance control centre 14 receives weather data from weather stations 12, traffic data from traffic sensors 13 and current pollutant and noise data measured by a network of immission sensors 16.

In addition thereto, data from on board sensors of vehicles which are, for example, fitted with a driver assistance system and are currently in the traffic system are transmitted to the traffic surveillance control centre 14 via the communication device 5.

This information is collected in a digital map 6 in the traffic surveillance control centre 14 and combined to form a three-dimensional and areal image of the immission, weather and traffic situations in the entire zone affected. Moreover, predictions for the further course of the stress from emission and traffic are made, for example, with the aid of simulation models, neuronal networks and/or fuzzy logic.

Traffic measures for influencing the traffic flows which are suitable for reducing the immission stress in particularly severely stressed zones can then be instituted by the traffic surveillance control centre 14 on the basis of the determined and/or predicted immission, weather and traffic situations. These traffic measures are implemented via a network of variable traffic signs and luminous signalling systems 15 in the traffic network. Interventions in vehicles which are equipped with the driver assistance system can be triggered in parallel with these traffic interventions via communication devices 5, for example with the aid of the communication between infrastructure and vehicle, for example beacons, radio communication and/or mobile communication. It is possible thereby substantially to raise the efficiency of a traffic surveillance system for influencing the pollutant and noise stress.

In principle, the driver assistance system can be operated autonomously by a vehicle, that is to say the decisions on interventions in the vehicle are taken in the information-processing unit 11 without synchronization with the traffic surveillance control centre 14 and without coordination with other vehicles or traffic interventions via the traffic infrastructure. However, also suitable for raising the efficiency is a close connection between the driver assistance system and the traffic surveillance control centre 14 in which the information processing and decision on interventions in the vehicle are moved from the information processing unit 11 on board the vehicle to the traffic surveillance control centre 14.

The information processing unit 11 in FIG. 3 contains a data memory 17 for holding all the data which are to be buffered. These can include both the input variables from digital map 6, locating unit 1, on board sensor system 2, immission sensor 3, traffic sensor 4 and communication device 5, and also data of internal units, for example feedback variables of units 7-10. Such internal units are, for example, the unit for determining the three-dimensional and/or areal traffic and immission situation (traffic and immission estimation), as well as for traffic and immission forecasting 21, and the controller 18 which supplies the outputs of the information processing unit 11. The unit for determining the three-dimensional and/or areal traffic and immission situation (traffic and immission estimation) and for traffic and immission prediction 21 receives the information required for estimation and prediction from the data memory 17 and likewise stores the results there. The controller 18 also not only receives from the memory information relating to the current traffic, weather and immission situation, but can also write data into the said memory in order, for example, to store the success of vehicle interventions undertaken for specific situations.

The traffic surveillance control centre 14 contains the units shown in FIG. 4: a digital map 6 which permits all the relevant data to be stored with reference to location; an immission calculation and prediction unit 19 which determines the three-dimensional and/or areal immission situation on the basis of data from the digital map, makes immission predictions and stores them in the digital map; and a traffic calculating and predicting unit 20 which determines the three-dimensional and/or areal traffic situation on the basis of data from the digital map 6 and makes traffic predictions and stores them in the digital map 6. A controller 22 receives immission estimates, for example actual values and/or predictions, from the digital map 6, and supplies as output suitable immission reducing measures which, in turn, can be stored in the digital map, for example in the form of statistics. This storage permits the management of measures together with their effect such that, for example, particularly effective measures can be determined, for example, as a function of the time of day or with reference to vehicle type, and can be used with preference. The traffic surveillance system thereby becomes a self-learning system.

1. Integrated traffic surveillance system having devices for measuring environmental and weather data (2, 3, 12, 16), having traffic sensors (4, 13), a traffic surveillance control centre (14) for storing and processing the detected data, and communication devices (5) for carrying out the data exchange with the measuring devices and with the data users,
characterized in that,
in order to reduce the environmental pollution actions are taken to control the traffic system which comprise the output of information and/or warnings and/or recommendations to road-users, interventions in the infrastructure (15) and/or interventions in the vehicle.

2. Traffic surveillance system according to claim 1,
characterized in that
the devices for measuring environmental and weather data (12, 16, 2, 3) comprise stationary and/or mobile measuring stations (12, 16) and/or sensor devices on the vehicle (2, 3).

3. Traffic surveillance system according to claim 1 or 2,
characterized in that
the traffic sensors (13, 4) are located in stationary and/or mobile traffic measuring stations and/or are fitted on the vehicle.

4. Traffic surveillance system according to one of the preceding claims,
characterized in that
the immission situation is detected and evaluated in three dimensions and/or over an area, and predictions are made for the further development of the immissions.

5. Traffic surveillance system according to one of the preceding claims,
characterized in that
the traffic and/or weather situation are detected and evaluated, predictions are made for their further development, and these data are taken into account in the measures taken.

6. Traffic surveillance system according to one of the preceding claims,
characterized in that
the traffic surveillance system comprises a digital map (6) into which data, in particular immission data, are entered as attributes.

7. Traffic surveillance system according to one of the preceding claims,
characterized in that
the immission data which are entered as attributes into the digital map (6) comprise the immission situation detected in three dimensions and/or over an area, the evaluation of this situation, predictions for the further development of the immissions, immission statistics, immission sensitivity and/or immission limit values.

8. Traffic surveillance system according to one of the preceding claims,
characterized in that
the integrated traffic surveillance system on board motor vehicles comprises a driver assistance system.

9. Traffic surveillance system according to one of the preceding claims,
characterized in that
the traffic surveillance control centre (14) and/or the driver assistance system undertake actions to control the traffic system, in order to reduce the environmental pollution.

10. Traffic surveillance system according to one of the preceding claims,
characterized in that
the control actions in the infrastructure of the traffic system comprise interventions in traffic surveillance installations, interventions in toll registration equipment, interventions in the control of systems that have an active effect on the surface condition of the road network, interventions in the control of luminous signal systems and/or interventions in the control of variable traffic signs.

11. Traffic surveillance system according to one of the preceding claims,
characterized in that
the road-users are informed optically and/or acoustically, as required, of the nature of the measures instituted.

12. Traffic surveillance system according to one of the preceding claims,
characterized in that
the control actions lower the stress from pollutants, smell and noise, particularly in specific problem zones of a traffic network, and/or globally reduce the environmental pollution.

13. Traffic surveillance system according to one of claims 8 to 12,
characterized in that
the driver assistance system in the vehicle comprises a digital map (6) with immission data as attributes.

14. Traffic surveillance system according to one of claims 8 to 13,
characterized in that
the driver assistance system independently determines the local, three-dimensional and/or areal immission, weather and/or traffic situations, makes predictions for the further development of the immission, weather and/or traffic situations, and evaluates the necessity of instituting measures.

15. Traffic surveillance system according to one of claims 8 to 14,
characterized in that
recommendations, instructions, information and/or warnings, in particular covering the traffic, weather and immission situation over wide areas and in regions and/or information for intervention in vehicle control are transmitted to the driver assistance system by the traffic surveillance control centre (14) via communication devices (5).

16. Traffic surveillance system according to one of claims 8 to 15,
characterized in that
recommendations, instructions, information and/or warnings, in particular detected sensor data, status data of the vehicle and/or positional data determined by the driver assistance system are transmitted to the traffic surveillance control centre (14) by the driver assistance system via communication devices (5).

17. Traffic surveillance system according to one of claims 8 to 16,
characterized in that
a route planning and destination guidance system (8) in the traffic surveillance control centre (14) and/or in the traffic assistance system takes account of immission points of view in route planning and destination guidance.

18. Traffic surveillance system according to one of claims 8 to 16,
characterized in that
on the basis of the determined immission, weather and/or traffic situation and the digital map (6) the driver is proposed an alternative driving route, or an alternative driving route that is kinder to the environment in the respective situation is selected automatically.

19. Traffic surveillance system according to one of claims 8 to 18,
characterized in that
the operating and display unit (9) is used to give the driver instructions, information, recommendations and/or warnings referring to driving style that are more environmentally friendly in the respective situation, and/or to specify to the driver and the other vehicle occupants options for switching to other means of transport that are more environmentally friendly in the respective situation.

20. Traffic surveillance system according to one of claims 8 to 19,
characterized in that,
within the scope of the measures taken, interventions in the control systems of the motor vehicle are undertaken which are suitable for lowering the emissions of the vehicle and/or the immissions in the vehicle.

21. Traffic surveillance system according to one of claims 8 to 20,
characterized in that,
within the scope of the measures taken, selection of the drive source of the motor vehicle is undertaken in order to lower the emissions of the vehicle and/or the immissions in the vehicle.

22. Traffic surveillance system according to one of claims 8 to 21,
characterized in that
the operating and display unit (9) is used to give the driver and the other vehicle occupants information, warnings, instructions and/or recommendations covering the vehicle interventions.

23. Traffic surveillance system according to one of claims 8 to 22,
characterized in that
a plurality of activation stages with different effects on the riding comfort and the emission of the vehicle are used when taking action to control the vehicle.

24. Traffic surveillance system according to one of the preceding claims,
characterized in that
the route planning and destination guidance system (8) takes account of immission points of view and/or traffic points of view and/or weather points of view when determining a start signal for a journey.

25. Traffic surveillance system according to one of the preceding claims,
characterized in that
all the road-users are taken into account when outputting instructions, recommendations, information and/or warnings such that, for example, pedestrians and cyclists are also able to avoid particularly polluted areas by means of appropriate optical and/or acoustic advice.

26. Traffic surveillance system according to one of the preceding claims,
characterized in that
in addition to the control actions for reducing the environmental pollution, control actions which serve to improve the traffic situation are also undertaken in the traffic system.

27. Traffic surveillance system according to one of the preceding claims,
characterized in that
the traffic surveillance system operates in a self-learning fashion.

28. Driver assistance system having a digital map of a traffic road network and means for determining position,
characterized in that
the driver assistance system determines the local, three-dimensional and/or areal immission, weather and/or traffic situations, makes predictions for the further development of the immission, weather and/or traffic situations, and evaluates the necessity of instituting measures.

29. Driver assistance system according to claim 28,
characterized in that
the driver assistance system comprises (2, 3, 4) devices for measuring environmental, weather and traffic data which are fitted on the vehicle.

30. Driver assistance system according to claim 28 or 29,
characterized in that
data, in particular immission data, are entered as attributes into the digital map (6).

31. Driver assistance system according to claim 28, 29 or 30,
characterized in that
the immission data which are entered as attributes into the digital map (6) comprise the three-dimensionally and/or areally detected immission situation, the evaluation of this situation, predictions for the further development of the immissions, immission statistics and statistic immission data such as immission sensitivity, immission test values and/or immission limit values.

32. Driver assistance system according to claims 28 to 31,
characterized in that
the route planning and destination guidance system (8) in the driver assistance system takes account in the case of route planning and destination guidance of immission points of view and/or weather points of view and/or traffic points of view.

33. Driver assistance system according to one of claims 28 to 32,
characterized in that
in order to reduce the traffic and/or environmental pollution outside the vehicle and/or to reduce the immission pollution in the vehicle, the driver assistance system takes measures which comprise the output of instructions, information, warnings and/or recommendations to the driver and the other vehicle occupants, and/or interventions in the vehicle.

34. Driver assistance system according to one of claims 28 to 33,
characterized in that
on the basis of the determined immission, weather and/or traffic situations and the digital map (6) the driver is proposed an alternative driving route, or an alternative driving route that is kinder to the environment in the respective situation is selected automatically.

35. Driver assistance system according to one of claims 28 to 34,
characterized in that
the operating and display unit (9) is used to give the driver instructions, information, recommendations and/or warnings referring to driving style that are more environmentally friendly in the respective situation, and/or to specify to the driver and the other vehicle occupants options for switching to other means of transport that are more environmentally friendly in the respective situation.

36. Driver assistance system according to one of claims 28 to 35,
characterized in that,
within the scope of the measures taken, interventions in the control systems of the motor vehicle are undertaken which are suitable for lowering the emissions of the vehicle and/or the immissions in the vehicle, and/or selection of the drive source of the motor vehicle is undertaken in order to lower the emissions of the vehicle and/or the immissions in the vehicle.

37. Driver assistance system according to one of claims 28 to 36,
characterized in that,
within the scope of the measures taken, the operating and display unit (9) is used to give the driver and the other vehicle occupants information, warnings, instructions and/or recommendations covering the vehicle interventions.

38. Driver assistance system according to one of claims 28 to 37,
characterized in that
a plurality of activation stages with different effects on the driver comfort and the vehicle emission are used for the interventions.

39. Vehicle assistance system according to one of claims 28 to 38,
characterized in that
the route planning and destination guidance system (8) takes account of immission points of view and/or traffic points of view and/or weather points of view when determining a start signal for a journey.

40. Driver assistance system according to one of claims 28 to 39,
characterized in that
the vehicle assistance system is part of the integrated traffic surveillance system.

41. Driver assistance system according to one of claims 28 to 40,
characterized in that
the driver assistance system operates in a self-learning fashion.

42. Digital map (6) of a traffic road network for a traffic surveillance system and/or a driver assistance system, which comprises route data relating to a traffic road network and assigned attributes,
characterized in that
the attributes comprise immission data.

43. Digital map (6) according to claim 42,
characterized in that
the data on the digital map comprise static and dynamic attributes.

44. Digital map (6) according to claim 42 or 43,
characterized in that
the static attributes comprise immission limit values, immission sensitivities, immission test values and/or immission statistics.

45. Digital map (6) according to claim 42, 43 or 44,
characterized in that
the dynamic attributes comprise immission pollution, immission predictions and/or immission statistics.

46. Digital map (6) according to claim 42, 43, 44 and 45,
characterized in that
the digital map is stored in the traffic surveillance control centre (14) and/or on board the vehicle.
